(19) United States
(12) Patent Application Publication
(10) Pub. No.: US 2020/0202434 A1
(43) Pub. Date: Jun. 25, 2020

(54) METHOD AND GUI FOR CREATING FUNGIBILITY IN A COMMODITY BACKED EXCHANGE TRADED SECURITY

(71) Applicant: ABAXX TECHNOLOGIES INC., TORONTO (CA)

(72) Inventors: JOSHUA CRUMB, CHRIST CHURCH (BB); ANDREW FEDAK, CHRIST CHURCH (BB); CHRISTOPHER A. WIKLOF, EVERETT, WA (US)

(21) Appl. No.: 16/706,457

(22) Filed: Dec. 6, 2019

Related U.S. Application Data
(60) Provisional application No. 62/776,356, filed on Dec. 6, 2018.

(51) Int. Cl. G06Q 40/04; G06Q 20/38; H04L 9/06

(52) U.S. Cl. CPC G06Q 40/04; G06Q 20/382; H04L 2209/38; H04L 9/0643; H04L 9/0637

(57) ABSTRACT

A computer method and graphical user interface (GUI) for transferring a commodity includes establishing a smart commodity contract carried on a distributed ledger for transfer of a commodity requiring plural steps before delivery, issuing a plurality of electronic tokens representing a completed delivery of the commodity, and displaying, on an electronic display of a user device, a GUI including an identity of the commodity contract with a future delivery date. A payment to a first party is transacted for at least a portion of costs corresponding to completion of a first step by executing a transaction on the distributed ledger. The payment to the first party may be made by transferring a portion of the issued tokens to an electronic wallet of the first party.

### CROSS-REFERENCE TO RELATED APPLICATIONS

The present application claims priority benefit from co-pending U.S. Provisional Patent Application No. 62/776,356, entitled “SYSTEM AND METHOD OF CREATING FUNGIBILITY IN A COMMODITY BACKED EXCHANGE TRADED SECURITY,” filed Dec. 6, 2018 (docket number 3058-007-02), which application, to the extent not inconsistent with the disclosure herein, is incorporated herein by reference.

### SUMMARY

According to an embodiment, a computer method and graphical user interface (GUI) for transferring a commodity includes establishing a smart commodity contract carried on a distributed ledger for transfer of a commodity, the contract including issuance of a plurality of electronic tokens allocated for each of a plurality of steps required for physical delivery of the commodity, and issuing the plurality of tokens each representing a portion of costs associated with the plurality of steps, the tokens cumulatively representing costs corresponding to a completed delivery of the commodity. The computer method and GUI includes displaying, on an electronic display of a user device, a graphical user interface (GUI) including an identity of the commodity contract with a future delivery date, a wallet object corresponding to an electronic transaction wallet, and a funds control object for executing a transfer of electronic funds from the transaction wallet. The computer method and GUI includes receiving a communication from a first party corresponding to physical completion of a step, the communication including a cost for completion of the step, and via the GUI, displaying a step status data object corresponding to the step completion and cost associated therewith. The computer method and GUI includes transacting a payment to the first party for at least a portion of costs corresponding to the first step completion by executing a transaction on the distributed ledger.

According to an embodiment, a computer method for transferring a commodity includes establishing a smart contract for transfer of a commodity requiring plural steps before delivery, issuing a plurality of tokens representing a completed delivery of the commodity, and receiving payment for the completed delivery from a buyer. The computer method includes transferring a first portion of the plurality of the tokens to a first party upon completion of a first step, while holding back an allocation of the plurality of the tokens sufficient to pay for one or more subsequent steps, and transferring a second portion of the plurality of the tokens to a second party upon completion of a second step.

### BRIEF DESCRIPTION OF THE DRAWINGS

FIG. 1 is a flow chart showing a computer method for use with a graphical user interface (GUI) for transferring a commodity, according to an embodiment.

FIG. 2 is a diagram of the graphical user interface (GUI) as described in the computer method of FIG. 1, according to an embodiment.

FIG. 3 is a flow chart showing a computer method for transferring a commodity, according to an embodiment.

FIG. 4 is a block diagram of a computer system configured to administer a commodity material transaction using a distributed ledger, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

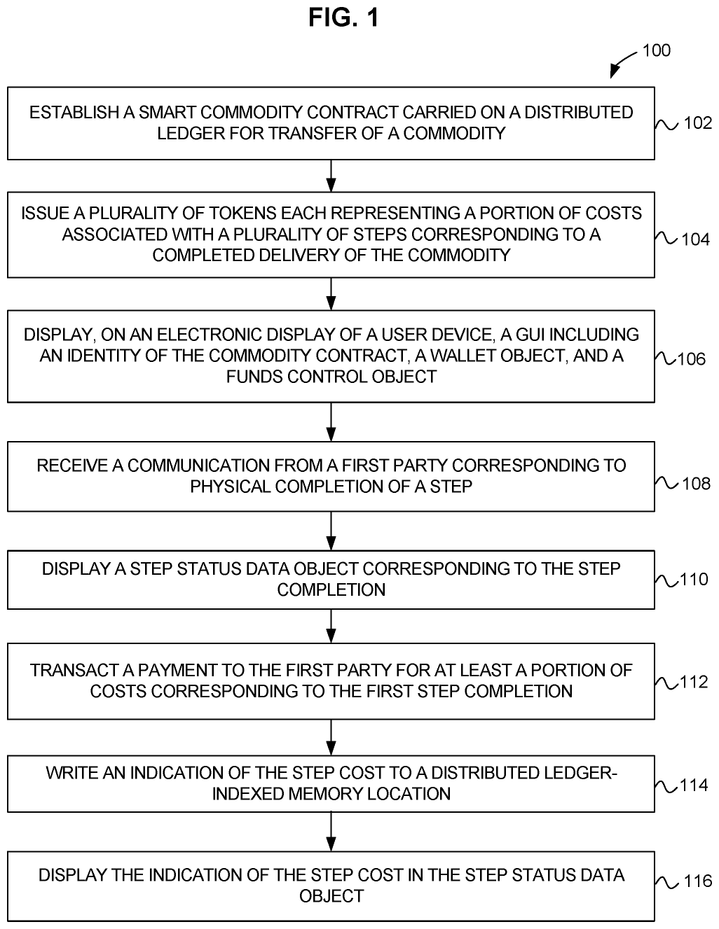

FIG. 1 is a flow chart showing a computer method 100 for use with a graphical user interface (GUI) 206 for transferring a commodity, according to an embodiment.

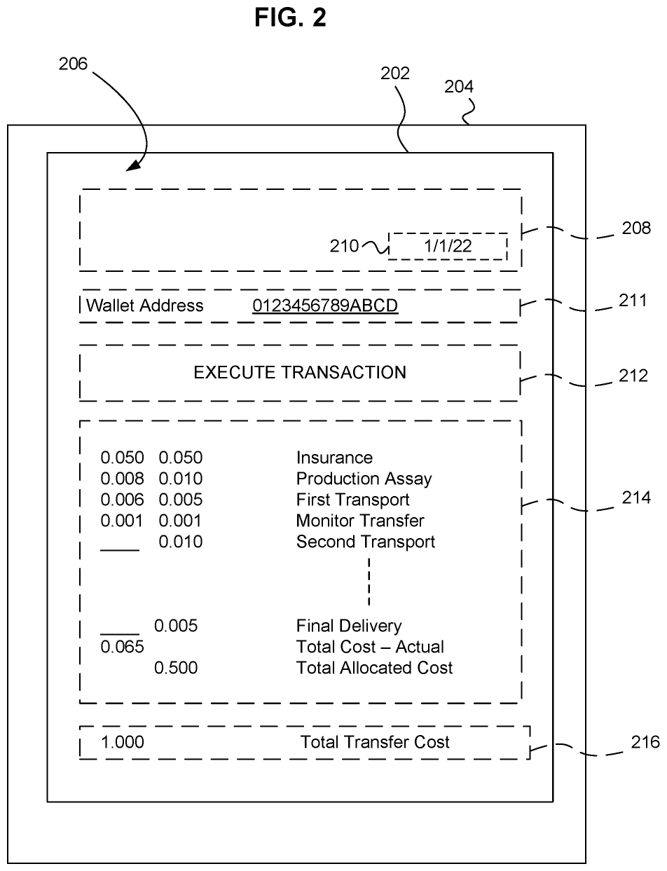

FIG. 2 is a diagram of the graphical user interface (GUI) 206 as described in the computer method 100 of FIG. 1, according to an embodiment.

According to an embodiment, referring to FIGS. 1 and 2, a computer method 100 and graphical user interface (GUI) 206 for transferring a commodity includes, in step 102, establishing a smart commodity contract carried on a distributed ledger for transfer of a commodity, the contract including issuance of a plurality of electronic tokens allocated for each of a plurality of steps required for physical delivery of the commodity. Step 104 includes issuing the plurality of tokens each representing a portion of costs associated with the plurality of steps, the tokens cumulatively representing costs corresponding to a completed delivery of the commodity. Step 106 includes displaying, on an electronic display 202 of a user device 204, a graphical user interface (GUI) 206 including an identity 208 of the commodity contract with a future delivery date 210, a wallet object 211 corresponding to an electronic transaction wallet, and a funds control object 212 for executing a transfer of electronic funds from the transaction wallet. Step 108 includes receiving a communication from a first party corresponding to physical completion of a step, the communication including a cost for completion of the step. Step 110 includes, via the GUI 206, displaying a step status data object 214 corresponding to the step completion. Step 112 includes transacting a payment to the first party for at least a portion of costs corresponding to the first step completion by executing a transaction on the distributed ledger to transfer at least a portion of the plurality of tokens from the transaction wallet to a first party wallet.

According to an embodiment, displaying a step status data object 214 corresponding to the step completion, in step 110, includes displaying a cost associated therewith.

According to an embodiment, the computer method 100 and graphical user interface (GUI) 206 for transferring a commodity further includes receiving input via the funds control object 212 prior to transacting the payment.

According to an embodiment, the computer method 100 and graphical user interface (GUI) 206 for transferring a commodity further includes transferring a first portion of the plurality of the tokens to the first party upon completion of the first step, the first portion of the plurality of tokens carrying a value corresponding to the at least a portion of costs. In one embodiment, transferring the first portion of the plurality of the tokens to the first party upon completion of the first step is executed while holding back an allocation of the plurality of the tokens sufficient to pay for one or more subsequent steps.

According to an embodiment, transacting the payment, in step 112, includes transferring a portion of the issued plurality of tokens. The portion of issued tokens transferred may carry a value equal to the first step cost. In one embodiment, transacting the payment, in step 112, further includes setting the portion of issued tokens transferred to a value just sufficient to cover actual costs plus profit. In another embodiment, transacting the payment, in step 112, further includes setting the portion of issued tokens transferred to a value just sufficient to cover a predetermined cost. Additionally and/or alternatively, transacting the payment, in step 112, further includes setting a uniform issued token value prior to completion of all steps, and selecting a number of transferred tokens to cover actual costs plus profit. In another embodiment, transacting the payment, in step 112, further includes setting a uniform issued token value prior to completion of all steps, and selecting a number of transferred tokens to cover a predetermined cost.

According to an embodiment, the computer method 100 and graphical user interface (GUI) 206 for transferring a commodity further includes, in step 114, writing an indication of the step cost to a distributed ledger-indexed memory location. Step 116 includes displaying, in the step status data object 214 in the GUI 206 on the electronic display 202 screen of the user device 204, the indication of the step cost. In one embodiment, displaying, in the step status data object 214, an indication of the step cost, in step 116, includes displaying an actual step cost. In another embodiment, displaying, in the step status data object 214, the indication of the step cost, in step 116, includes displaying a projected step cost. Additionally and/or alternatively, displaying, in the step status data object 214, the indication of the step cost, in step 116, includes displaying, in a total cost data object 216, a cumulative or total cost for the plurality of steps. In another embodiment, displaying, in the step status data object 214, the indication of the step cost, in step 116, includes displaying a total original token value, a projected delivery value, and a total current token value.

According to an embodiment, the computer method 100 and graphical user interface (GUI) 206 for transferring a commodity further includes transacting a payment to a second party for at least a portion of costs corresponding to a second step completion by executing a second transaction on the distributed ledger.

According to an embodiment, the commodity is a physical commodity. In one embodiment, the first step includes a first process for preparing the commodity for delivery and the first party is involved in the first process. The first step may include generating the commodity or a precursor to the commodity. Additionally and/or alternatively, the first step may include processing the commodity or a precursor to the commodity. In another embodiment, the first step may include transporting the commodity or a precursor to the commodity.

According to an embodiment, the commodity is food. In one embodiment, the first step includes an aspect of farming the food or a precursor to the food. In another embodiment, the first step includes harvesting the food. Additionally and/or alternatively, the first step includes processing the food or the precursor to the food. In one embodiment, the food is meat. In another embodiment, the food is plant based. According to an embodiment, the second step includes processing the food or the precursor to the food. The second step may include transporting the food or the precursor to the food. In another embodiment, the second step includes delivering the food.

According to an embodiment, the commodity includes a fuel. The fuel may include a petroleum product. In another embodiment, the fuel includes coal. According to an embodiment, the first step includes extracting the fuel. In another embodiment, the first step includes transporting the fuel. Additionally and/or alternatively, the first step includes processing the fuel. Processing the fuel may include refining the fuel. According to another embodiment, the second step includes processing the fuel. The second step may include transporting the fuel.

According to an embodiment, the commodity includes a metal. In one embodiment, the first step includes extracting the metal from the earth. In another embodiment, the first step includes processing the metal. Processing the metal may include refining the metal. In another embodiment, the first step includes transporting the metal. According to an embodiment, the second step includes processing the metal. The second step may include transporting the metal. The metal may include one or more of copper, aluminum, tungsten, iron, tantalum, and a rare earth metal.

According to an embodiment, the distributed ledger includes a blockchain. In one embodiment, the blockchain includes a public blockchain. In another embodiment, the blockchain includes a private blockchain. Additionally and/or alternatively, the blockchain includes a permissioned blockchain.

According to an embodiment, the smart contract is added to the distributed ledger as a transaction. Adding the smart contract to the distributed ledger may include encrypting the smart contract. In one embodiment, adding the smart contract to the distributed ledger includes storing the smart contract at one or more cloud locations, encrypting the one or more cloud locations, and entering the encrypted one or more cloud locations onto the distributed ledger as a transaction.

According to an embodiment, the computer method 100 and graphical user interface (GUI) 206 for transferring a commodity further includes, upon completion of the first step, recording in the distributed ledger that the first party has completed the first step. According to another embodiment, the computer method 100 and graphical user interface (GUI) 206 for transferring a commodity further includes, upon transferring the first portion of the plurality of the tokens to the first party, recording the transfer of the first portion of the plurality of the tokens to the first party in the distributed ledger.

According to an embodiment, transacting the payment to the first party for at least the portion of the costs corresponding to the first step completion by executing a transaction on the distributed ledger, in step 112, includes converting the tokens to a cryptocurrency and delivering the cryptocurrency to the first party. According to another embodiment, transacting the payment to the first party for at least the portion of the costs corresponding to the first step completion by executing a transaction on the distributed ledger, in step 112, includes converting the tokens to a fiat currency and delivering the fiat currency to the first party.

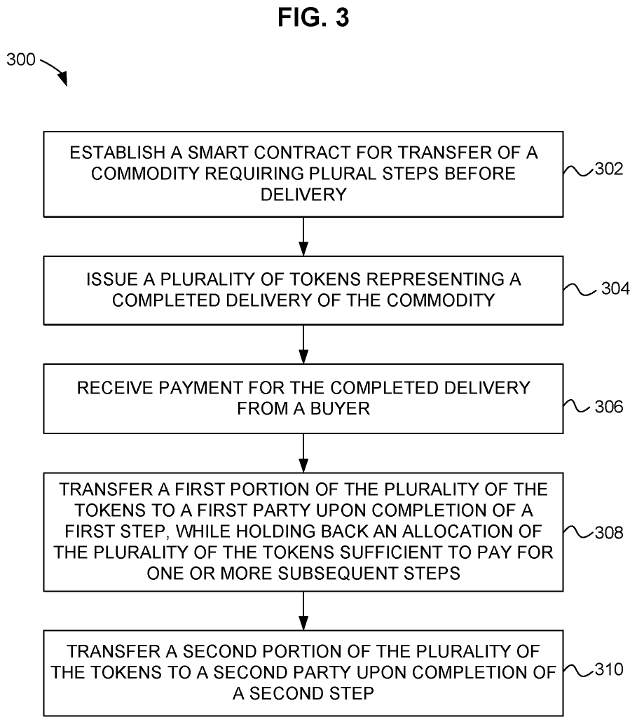

FIG. 3 is a flow chart showing a computer method 300 for transferring a commodity, according to an embodiment.

According to an embodiment, the computer method 300 for transferring a commodity includes, in step 302, establishing a smart contract for transfer of a commodity requiring plural steps before delivery. Step 304 includes issuing a plurality of tokens representing a completed delivery of the commodity. Step 306 includes receiving payment for the completed delivery from a buyer. Step 308 includes transferring a first portion of the plurality of the tokens to a first party upon completion of a first step, while holding back an allocation of the plurality of the tokens sufficient to pay for one or more subsequent steps. Step 310 includes transferring a second portion of the plurality of the tokens to a second party upon completion of a second step.

According to an embodiment, the commodity is a physical commodity.

According to an embodiment, in step 308, the first step includes a first process for preparing the commodity for delivery and the first party is involved in the first process. In an embodiment, in step 310, the second step includes a second process for preparing the commodity for delivery and the second party is involved in the second process. In an embodiment, the first process takes place prior to the second process.

According to an embodiment, in step 308, the first step includes generating the commodity or a precursor to the commodity. Additionally and/or alternatively, in step 308, the first step includes processing the commodity or a precursor to the commodity. In another embodiment, in step 308, the first step includes transporting the commodity or a precursor to the commodity.

According to an embodiment, in step 310, the second step includes processing the commodity or the precursor to the commodity. Additionally and/or alternatively, in step 310, the second step includes transporting the commodity. In another embodiment, in step 310, the second step includes testing or verifying the commodity.

According to an embodiment, the commodity may be food. In an embodiment, in step 308, the first step includes an aspect of farming the food or a precursor to the food. In another embodiment, in step 308, the first step includes harvesting the food. Additionally and/or alternatively, in step 308, the first step includes processing the food or the precursor to the food. In various embodiments, the food may be meat or plant based.

According to an embodiment, in step 310, the second step includes processing the food or the precursor to the food. In another embodiment, in step 310, the second step includes transporting the food or the precursor to the food. Additionally and/or alternatively, in step 310, the second step includes delivering the food.

According to an embodiment, the commodity may include a fuel. In one embodiment, the fuel may include a petroleum product. In another embodiment, the fuel may include coal. According to an embodiment, in step 308, the first step includes extracting the fuel. Additionally and/or alternatively, in step 308, the first step includes transporting the fuel. In another embodiment, in step 308, the first step includes processing the fuel. In an embodiment, processing the fuel includes refining the fuel. According to an embodiment, in step 310, the second step includes processing the fuel. Additionally and/or alternatively, in step 310, the second step includes transporting the fuel.

According to an embodiment, the commodity may include a metal. According to an embodiment, in step 308, the first step includes extracting the metal from the earth. Additionally and/or alternatively, in step 308, the first step includes processing the metal. In one embodiment, processing the metal includes refining the metal. In another embodiment, in step 308, the first step includes transporting the metal. According to an embodiment, in step 310, the second step includes processing the metal. Additionally and/or alternatively, in step 310, the second step includes transporting the metal. In various embodiments, the metal includes one or more of copper, aluminum, tungsten, iron, tantalum, and a rare earth metal.

According to an embodiment, in step 302, establishing the smart contract includes establishing the smart contract in a distributed ledger. In an embodiment, the distributed ledger includes a blockchain. In one embodiment, the blockchain includes a public blockchain. In another embodiment, the blockchain includes a private blockchain. Additionally and/or alternatively, the blockchain includes a permissioned blockchain. In one embodiment, the smart contract is added to the distributed ledger as a transaction. In an embodiment, adding the smart contract to the distributed ledger comprises encrypting the smart contract. In another embodiment, adding the smart contract to the distributed ledger includes storing the smart contract at one or more cloud locations, encrypting the one or more cloud locations, and entering the encrypted one or more cloud locations onto the distributed ledger as a transaction.

According to an embodiment, the computer method 300 further includes, in step 308, upon completion of the first step, recording in the distributed ledger that the first party has completed the first step.

According to an embodiment, the computer method 300 further includes, in step 308, upon transferring the first portion of the plurality of the tokens to the first party, recording transfer of the first portion of the plurality of the tokens to the first party in the distributed ledger.

According to an embodiment, the computer method 300 further includes, in step 310, upon completion of the second step, recording in the distributed ledger that the second party has completed the second step.

According to an embodiment, the computer method 300 further includes, in step 310, upon transferring the second portion of the plurality of the tokens to the second party, recording transfer of the second portion of the plurality of the tokens to the second party in the distributed ledger.

According to an embodiment, in step 308, transferring the first portion of the plurality of the tokens to the first party upon completion of the first step includes converting the tokens to a cryptocurrency and delivering the cryptocurrency to the first party. In another embodiment, in step 308, transferring the first portion of the plurality of the tokens to the first party upon completion of the first step includes converting the tokens to a fiat currency and delivering the fiat currency to the first party.

According to an embodiment, in step 310, transferring the second portion of the plurality of the tokens to the second party upon completion of the second step includes converting the tokens to a cryptocurrency and delivering the cryptocurrency to the second party. In another embodiment, in step 310, transferring the second portion of the plurality of the tokens to the second party upon completion of a second step includes converting the tokens to a fiat currency and delivering the fiat currency to the second party.

According to an embodiment, the buyer is a commodity trader. According to an embodiment, a total number of tokens is specified in the smart contract. In one embodiment, the portion of the plurality of the tokens to be delivered to each party is specified in the smart contract. In another embodiment, the portion of the plurality of the tokens to be delivered to each party is dynamically determined upon completion of the step associated with the party.

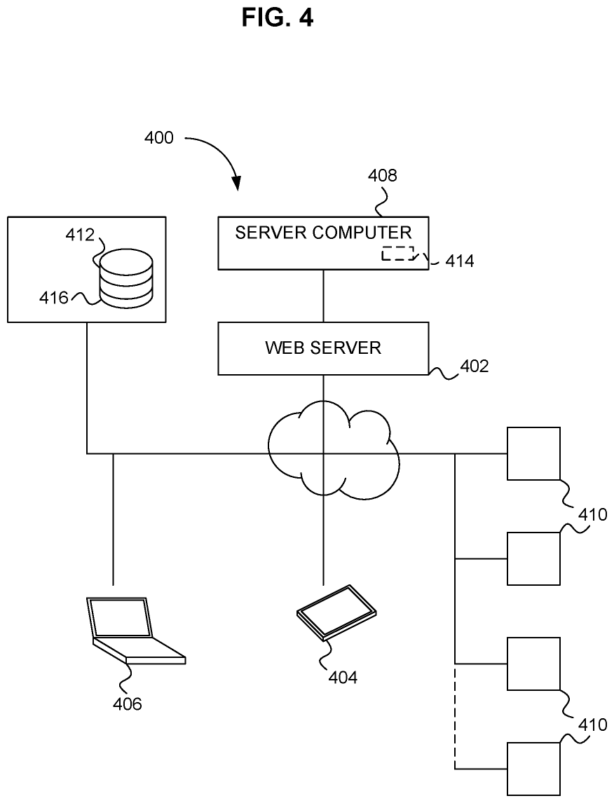

FIG. 4 is a block diagram of a computer system 400 configured to administer a commodity material transaction using a distributed ledger, according to an embodiment. As used herein, the term distributed ledger will be understood to include blockchains of various ilks. Illustrated elements described in conjunction with this figure may be described elsewhere herein and may bear dissimilar reference numbers. Corresponding elements will be understood as equivalent as indicated by context.

According to an embodiment, the computer system 400 may include a web server 402 configured to output a first GUI to a first device 404 for a party to receive and display information related to a commodity material transaction smart contract, according to an embodiment. The web server 402 may be further configured to output a second GUI to a second device 406 for a counterparty to receive and display information related to a commodity material transaction smart contract, according to an embodiment. The computer system 400 may include a server computer 408, operatively coupled to the web server 402, and configured to execute data transfer and distributed ledger transactions. The server computer 408 may be further configured to transmit display data to and receive user input from the web server 402, for relay to and from the first and second devices 404, 406.

According to an embodiment, the computer system 400 may include a plurality of devices 410 operatively coupled to the web server 402 and carrying the distributed ledger. The web server 402 may be configured to transmit the distributed ledger transactions to the plurality of devices 410, according to an embodiment. The plurality of devices 410 may be configured to collectively validate the distributed ledger transactions, according to an embodiment. The web server 402 may be configured to receive and forward collective validation to the server computer 408, according to an embodiment.

According to an embodiment, the server computer 408 may be further configured to transfer a first cryptocurrency and/or digital security associated with commodity transactions corresponding to transactions between a counterparty wallet 412 and a transaction wallet 414 via the web server 402. The server computer 408 may issue a distributed ledger token corresponding to one or more commodity material transactions, according to an embodiment.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A computer and graphical user interface (GUI) method for transferring a commodity, comprising:
establishing a commodity smart contract carried on a distributed ledger for transfer of a commodity, the smart contract including issuance of a plurality of electronic tokens allocated for each of a plurality of steps required for delivery of a physical commodity;
issuing the plurality of tokens each representing a portion of cost associated with the plurality of steps, the tokens cumulatively representing costs corresponding to a completed delivery of the commodity;
displaying, on an electronic display of a user device, a graphical user interface (GUI) including an identity of the commodity smart contract with a future delivery date, a wallet object corresponding to an electronic transaction wallet, and a funds control object for executing a transfer of electronic funds from the transaction wallet;
receiving, from a first party, a communication corresponding to physical completion of a step of the plurality of steps, the communication including a cost for completion of the step;
via the GUI, displaying a step status data object corresponding to completion of the step; and
transacting a payment to the first party for at least a portion of costs corresponding to completion of the step of the plurality of steps by executing a transaction on the distributed ledger to transfer at least a portion of the plurality of tokens from the transaction wallet to a first party wallet.

2. The computer method and graphical user interface (GUI) for transferring a commodity of claim 1,
wherein displaying a step status data object corresponding to the step completion includes displaying a cost associated therewith.

3. The computer method and graphical user interface (GUI) for transferring a commodity of claim 1, further comprising receiving input via the funds control object prior to transacting the payment.

4. The computer method and graphical user interface (GUI) for transferring a commodity of claim 1, further comprising transferring a first portion of the plurality of the tokens to the first party upon completion of the first step, the first portion of the plurality of tokens carrying a value corresponding to the at least a portion of costs.

5. The computer method and graphical user interface (GUI) for transferring a commodity of claim 4, wherein transferring the first portion of the plurality of the tokens to the first party upon completion of the first step is executed while holding back an allocation of the plurality of the tokens sufficient to pay for one or more subsequent steps.

6.-9. (canceled)

10. The computer method and graphical user interface (GUI) for transferring a commodity of claim 1, further comprising setting a uniform issued token value prior to completion of all steps; and
selecting a number of transferred tokens to cover actual costs plus profit.

11. The computer method and graphical user interface (GUI) for transferring a commodity of claim 1, further comprising setting a uniform issued token value prior to completion of all steps; and
selecting a number of transferred tokens to cover a predetermined cost.

12. The computer method and graphical user interface (GUI) for transferring a commodity of claim 1, further comprising writing an indication of a step cost to a distributed ledger-indexed memory location; and
displaying, in the step status data object in the GUI on the electronic display screen of the user device, the indication of the step cost.

13. The computer method and graphical user interface (GUI) for transferring a commodity of claim 12, wherein displaying, in the step status data object, the indication of the step cost includes displaying a projected step cost and an actual step cost.

14. The computer method and graphical user interface (GUI) for transferring a commodity of claim 12, wherein displaying, in the step status data object, the indication of the step cost includes displaying one or more of a projected step cost, a cumulative cost for the plurality of steps, a total original token value, a projected delivery value or a total current token value.

15.-16. (canceled)

17. The computer method and graphical user interface (GUI) for transferring a commodity of claim 1, further comprising:
transacting a payment to a second party for at least a portion of costs corresponding to completion of a second step of the plurality of steps by executing a second transaction on the distributed ledger.

18. (canceled)

19. The computer method and graphical user interface (GUI) for transferring a commodity of claim 1,
wherein the step includes testing or verifying the commodity.

20. The computer method and graphical user interface (GUI) for transferring a commodity of claim 1, wherein the step includes generating the commodity or a precursor to the commodity.

21. The computer method and graphical user interface (GUI) for transferring a commodity of claim 1, wherein the step includes processing the commodity or a precursor to the commodity.

22. The computer method and graphical user interface (GUI) for transferring a commodity of claim 1, wherein the step includes transporting the commodity or a precursor to the commodity.

23-32. (canceled)

33. The computer method and graphical user interface (GUI) for transferring a commodity of claim 1, wherein the commodity includes a petroleum product.

34-48. (canceled)

49. The computer method and graphical user interface (GUI) for transferring a commodity of claim 1, wherein the distributed ledger includes a blockchain.

50-52. (canceled)

53. The computer method and graphical user interface (GUI) for transferring a commodity of claim 1, further comprising adding the smart contract to the distributed ledger as a transaction.

54. The computer method and graphical user interface (GUI) for transferring a commodity of claim 53, wherein adding the smart contract to the distributed ledger comprises encrypting the smart contract.

55. The computer method and graphical user interface (GUI) for transferring a commodity of claim 53, wherein adding the smart contract to the distributed ledger comprises:
storing the smart contract at one or more networked storage locations;
encrypting the one or more networked storage locations; and
entering the encrypted one or more networked storage locations onto the distributed ledger as a transaction.

56. The computer method and graphical user interface (GUI) for transferring a commodity of claim 1, further comprising, upon completion of the step, recording in the distributed ledger that the first party has completed the step.

57. The computer method and graphical user interface (GUI) for transferring a commodity of claim 56, further comprising, upon transferring the first portion of the plurality of the tokens to the first party, recording the transfer of the first portion of the plurality of the tokens to the first party in the distributed ledger.

58. The computer method and graphical user interface (GUI) for transferring a commodity of claim 1, wherein transacting the payment to the first party for at least the portion of the costs corresponding to the step completion by executing a transaction on the distributed ledger includes converting the tokens to a cryptocurrency and delivering the cryptocurrency to the first party.

59. The computer method and graphical user interface (GUI) for transferring a commodity of claim 1, wherein transacting the payment to the first party for at least the portion of the costs corresponding to the step completion by executing a transaction on the distributed ledger includes converting the tokens to a fiat currency and delivering the fiat currency to the first party.

60. A computer method for transferring a commodity, comprising:
establishing a smart contract for transfer of a physical commodity requiring plural steps before delivery;
issuing a plurality of tokens representing a completed delivery of the commodity;
receiving payment for the completed delivery from a buyer;
transferring a first portion of the plurality of the tokens to a first party upon completion of a first step, while holding back an allocation of the plurality of the tokens sufficient to pay for one or more subsequent steps; and
transferring a second portion of the plurality of the tokens to a second party upon completion of a second step.

61. (canceled)

62. The computer method for transferring a commodity of claim 60,
wherein the first step includes a first process for preparing the commodity for delivery and the first party is involved in the first process;
wherein the second step includes a second process for preparing the commodity for delivery and the second party is involved in the second process; and
wherein the first process takes place prior to the second process.

63.-94. (canceled)

95. The computer method for transferring a commodity of claim 60, wherein establishing the smart contract includes establishing the smart contract in a distributed ledger.

96. The computer method for transferring a commodity of claim 95, wherein the distributed ledger includes a blockchain.

97-99. (canceled)

100. The computer method for transferring a commodity of claim 95, comprising adding the smart contract to the distributed ledger as a transaction.

101. The computer method for transferring a commodity of claim 100, wherein adding the smart contract to the distributed ledger comprises encrypting the smart contract.

102. The computer method for transferring a commodity of claim 100, wherein adding the smart contract to the distributed ledger comprises:
storing the smart contract at one or more networked storage locations;
encrypting the one or more networked storage locations; and
entering the encrypted one or more networked storage locations onto the distributed ledger as a transaction.

103. The computer method for transferring a commodity of claim 95, further comprising, upon completion of the first step, recording in the distributed ledger that the first party has completed the first step.

104. The computer method for transferring a commodity of claim 103, further comprising, upon transferring the first portion of the plurality of the tokens to the first party, recording transfer of the first portion of the plurality of the tokens to the first party in the distributed ledger.

105. The computer method for transferring a commodity of claim 95, further comprising, upon completion of the second step, recording in the distributed ledger that the second party has completed the second step.

106. The computer method for transferring a commodity of claim 105, further comprising, upon transferring the second portion of the plurality of the tokens to the second party, recording transfer of the second portion of the plurality of the tokens to the second party in the distributed ledger.

107.-108. (canceled)

109. The computer method for transferring a commodity of claim 60, wherein transferring the second portion of the plurality of the tokens to the second party upon completion of the second step includes converting the tokens to a cryptocurrency and delivering the cryptocurrency to the second party.

110. The computer method for transferring a commodity of claim 60, wherein transferring the second portion of the plurality of the tokens to the second party upon completion of a second step includes converting the tokens to a fiat currency and delivering the fiat currency to the second party.

111. (canceled)

112. The computer method for transferring a commodity of claim 60, wherein a total number of tokens is specified in the smart contract.

113. The computer method for transferring a commodity of claim 112, wherein the portion of the plurality of the tokens to be delivered to each party is specified in the smart contract.

114. The computer method for transferring a commodity of claim 60, wherein the portion of the plurality of the tokens to be delivered to each party is dynamically determined upon completion of the step associated with the party.
